(19) United States
(12) Patent Application Publication
(10) Pub. No.: US 2006/0001220 A1
(43) Pub. Date: Jan. 5, 2006

(54) Metallic cylinder head gasket for an internal combustion engine with sleeve

(76) Inventors: Harald Rebien, Neu-Ulm (DE); Bernd Ruess, Vohringen (DE); Thomas Görtler, Weissenhorn (DE); Alfred Weiss, Neu-Ulm (DE); Andreas Göttler, Ulm (DE)

Correspondence Address: RADER, FISHMAN & GRAUER PLLC, 39533 WOODWARD AVENUE, SUITE 140, BLOOMFIELD HILLS, MI, 48304-0610, US

(21) Appl. No.: 11/153,004

(22) Filed: Jun. 15, 2005

(30) Foreign Application Priority Data
Jun. 17, 2004 (DE) 10 2004 029 351.1

(51) Int. Cl. F02F 11/00

(52) U.S. Cl. 277/591

(57) ABSTRACT

The invention relates to a metallic cylinder head gasket for an internal combustion engine with sleeve, which comprises at least one metallic layer and has at least one combustion chamber opening and further openings, e.g. for fluids. By means of the cylinder head gasket according to the invention, a seal of a wet cylinder sleeve relative to the cooling water or combustion gases at the upper sleeve edge can be effected.

The invention relates to a metallic cylinder head gasket for an internal combustion engine with sleeve, which comprises at least one metallic layer and has at least one combustion chamber opening and further openings, e.g. for fluids. By means of the cylinder head gasket according to the invention, an additional seal of a wet cylinder sleeve relative to the cooling water or combustion gases at the upper sleeve edge can be effected.

Engines with pressed-in or inserted sleeves, so-called sleeve engines, with cylinder sleeves cooled by cooling water require sealing of the joint position between cylinder block and sleeve collar. As a result, liquid is prevented from passing through the annular gap between engine block and cylinder sleeve into the region of the upper engine block or sleeve result, liquid is prevented from passing through the annular gap between engine block and cylinder sleeve into the region of the upper engine block or sleeve sealing face, on which a cylinder head gasket which is clamped between the engine block and cylinder sleeve on the lower side and a cylinder head on the upper side is positioned. Commercially available cylinder sleeves have a sleeve cylinder in which a piston moves to and from in the direction of the sleeve axis, and also a sleeve collar which protrudes radially outwardly beyond the sleeve cylinder, the precise position of said sleeve collar depending upon the constructional principle. The engine block has an axial first recess for inserting the sleeve cylinder and a second recess of a larger diameter which is circular in plan view and situated between the first recess and the upper engine block sealing face for receiving and supporting the sleeve collar. In order to cool the sleeve, cooling water enters into the annular gap between the sleeve cylinder and the engine block from the bottom.

Various variants for sealing the annular gap are known from the state of the art, with which the passage of cooling water at the edge orientated towards the cylinder head between the cylinder sleeve and the engine block can be prevented. The first variant provides that, between a lower annular end face of the sleeve collar and an annular base face of the second engine block recess receiving the sleeve collar, a sealing element in the form of a metal ring is inserted, which is clamped in the axial direction between the sleeve collar and the engine block when tightening the cylinder head screws. This metal ring normally comprises a copper-zinc alloy. This metal ring is exposed to extremely high dynamic stresses respect to the sleeve axis between those faces of the sleeve collar and of the engine block between which the metal ring is clamped. Sliding movements of this type can be attributed to the fact that the cylinder sleeve is widened by the high pressures which occur periodically in the combustion chamber surrounded by the sleeve. Likewise the result is different heat expansions due to the different temperatures of sleeve and engine block and possibly different materials of these two components. The stressing of the metal ring which can be attributed to these sliding movements can lead to damage thereof and hence also to damage to the sealing system.

A second variant for the seal provides that the outer circumference of the sleeve cylinder is provided with an annular groove into which an O-ring made of elastomeric material is inserted, which ring is then clamped between the surrounding wall of the engine block recess receiving the sleeve cylinder and the sleeve cylinder. This sealing system requires an annular groove for receiving the O-ring. This variant for the seal presents the disadvantage that no cooling can be effected in the upper region of the cylinder sleeve and the life expectancy of the elastomer is limited due to its thermal sensitivity.

Furthermore, two further variants of a sealing element are known from DE 102 05 179 A1 and DE 102 05 180 A1. One provides that the sealing element has a metallic (preferably from spring steal), annular sealing element which can be resiliently deformed in the radial direction and encompasses the sleeve collar, and is clamped between the outer circumference thereof and a circumferential wall of the engine block recess. Another variant provides that the sealing element has an elastomeric, annular sealing element which encompasses the sleeve collar and is clamped between the outer circumference thereof and the circumferential wall of the engine block recess. The sealing element is thereby constructed from the elastomeric sealing ring and a carrier ring made of metal or a deformation-resistant and temperature-resistant plastic material.

All the variants of the state of the art described here have in common that they concern seals of the annular gap in the radial direction. This presents the disadvantage that sealing elements of this type must be manufactured separately and, with partially complex adaptation of the components to be sealed, represent an additional method step in production.

Starting herefrom, it was the object of the present invention to produce a seal between the engine block and cylinder sleeve, in which the sealing element is already integrated in components to be used so that the number of components to be used is reduced and hence the production process is simplified and thus becomes more economical.

This object is achieved by the metallic cylinder head gasket having the features of claim 1. The further dependent claims reveal advantageous developments. The use of the metallic cylinder head gasket according to the invention is described in claim 11.

According to the invention, a metallic cylinder head gasket for an internal combustion engine with sleeve is provided, which comprises at least one metallic layer, in which at least one combustion chamber opening and further openings, e.g. for fluids, are formed. An annular elastic element is integrated in the at least one metallic layer in the region abutting against the combustion chamber through-opening, said element surrounding the combustion chamber through-opening entirely. The elastic element is hereby configured and integrated in the at least one metallic layer in such a manner that, in the installed state, it bridges the joint position between the cylinder block and the sleeve collar.

By means of the cylinder head gasket according to the invention, a seal of the annular gap at the joint position between the cylinder block and the sleeve collar can be achieved so that a seal of a wet cylinder sleeve relative to cooling water or combustion gases can be produced at the upper sleeve edge. In contrast to the sealing techniques known from the state of the art, this hereby concerns an axial seal by means of the cylinder head gasket which is modified according to the invention.

Preferably, the elastic element comprises a metal sheet which has two members and is manufactured preferably from spring steel. A metal sheet of this type, which is preferably beaded, is attached preferably at least partially across the circumference thereof by welding, soldering, gluing or mechanical restraining on the at least one metallic layer of the cylinder head gasket. However, an embodiment is also conceivable in which the elastic element is merely inserted. One member of the metal sheet functioning as a rocker comes thereby to abut on the cylinder block, whilst the other free member of the metal sheet abuts on the sleeve collar. The advantage of this rocker construction according to the invention is that not only does the bead have an elastic effect but also the height compensation from one member to the other effects an equalising function during axial sleeve movement.

In a preferred embodiment, the elastic element has a functional surface coating on one and/or both sides. A corresponding coating can thereby take over the microsealing. Comparable solutions with soft material layers or also elastomers are likewise possible. Likewise, sliding coatings can be used preferably. Combinations of the above-mentioned layers and coatings are likewise possible.

Preferably, the free members, in the installed state, engage respectively in an annular groove in the cylinder block and/or in the sleeve collar. It is possible as a result that an additional protection is achieved for relative movements which occur.

In a further preferred embodiment, the elastic element can comprise a metal sheet made of spring steel which has two free members, rubber buffers being disposed on the side orientated away from the at least one continuous metallic sealing layer in the region of the respective member ends, said rubber buffers being situated, in the installed state, one on the cylinder block and one on the sleeve collar. To compensate for different dynamic actual movements of cylinder block and sleeves, the rubber buffers can preferably have a different height. There should be understood by rubber buffers in the sense of the invention, not only buffers made of rubber but in general buffers made of elastomers or polymers, with or without fibre reinforcement.

As a further variant, it is preferred that the elastic element comprises two rubber buffers which are fitted directly on the underside of the at least one continuous sealing layer and, in the installed state abut, one on the cylinder block and one on the sleeve collar.

The metallic cylinder head gasket according to the invention is used for internal combustion engines with sleeves, so-called sleeve engines, in order to seal cylinder sleeves relative to cooling water or combustion gases at the upper sleeve edge.

One particular advantage of the metallic cylinder head gasket according to the invention, described here, is based on the fact that the sealing function is integrated in the cylinder head gasket as additional functionality, which leads to less assembly complexity and cost expenditure. Furthermore, the elastic elements used for sealing are extensively insensitive to temperature and media.

The subject according to the application is intended to be explained in more detail with reference to the subsequent Figures without said subject being restricted to the embodiments shown here by way of example. Moreover, the invention is not depending on the axial position of the contacting collar between sleeve and cylinder block, thus it can be used for mid-stop and top-stop sleeve constructions, respectively.

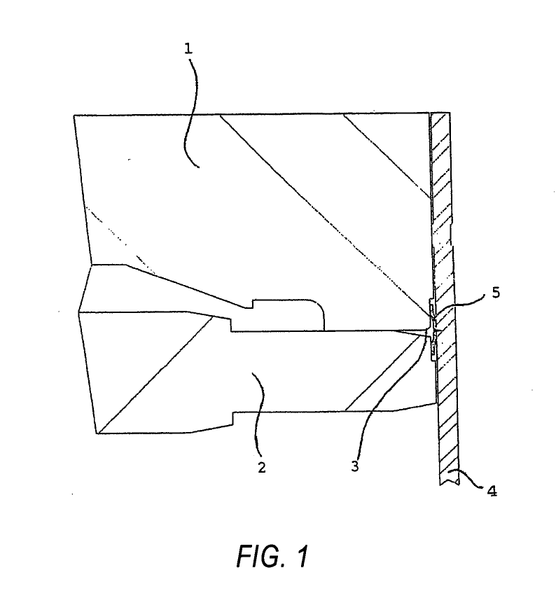

FIG. 1 shows the cross-section of a cylinder head gasket according to the invention in conjunction with a cylinder block and a sleeve of a sleeve engine,

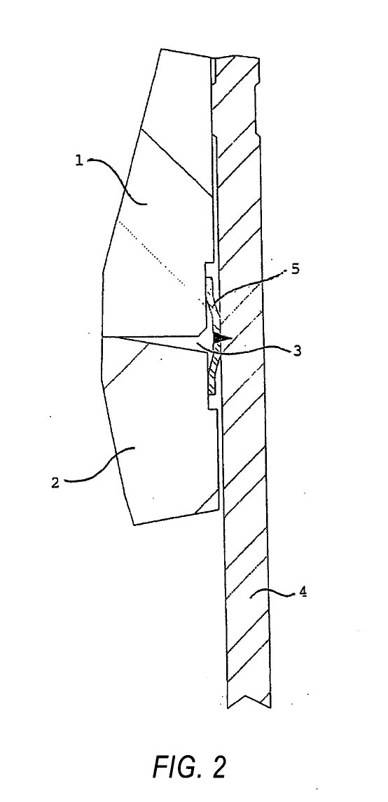

FIG. 2 shows a first variant of a cylinder head gasket according to the invention,

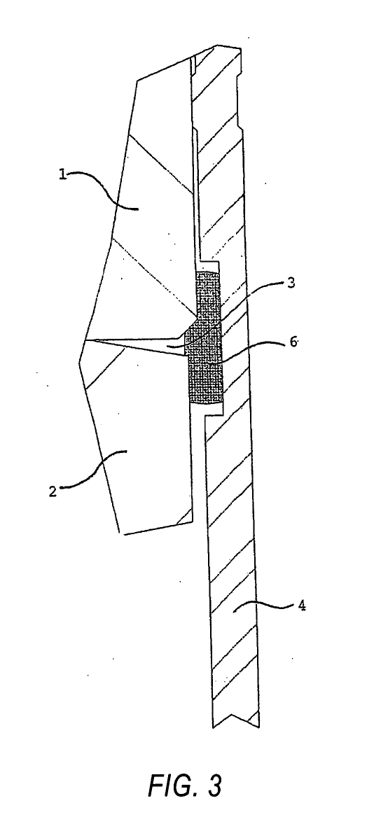

FIG. 3 shows a second variant of a cylinder head gasket according to the invention,

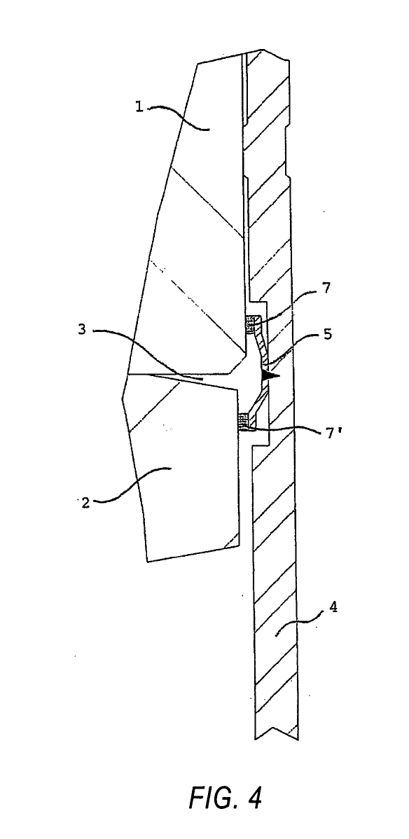

FIG. 4 shows a third variant of a cylinder head gasket according to the invention and

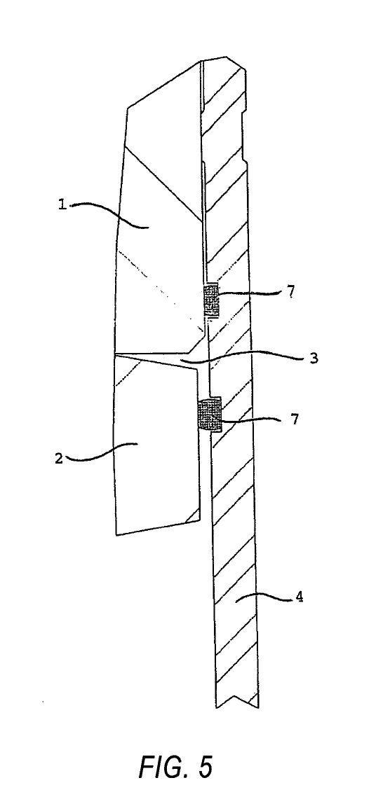

FIG. 5 shows a fourth embodiment of a cylinder head gasket according to the invention.

In FIG. 1, the cross-section of an internal combustion engine with sleeve is illustrated in the region of the joint position between the cylinder block 1 and the sleeve collar 2. At this joint position, there is an annular gap 3 formed at the upper sleeve edge. It is the object of the cylinder head gasket according to the invention to achieve a seal relative to combustion gases or cooling water at this upper sleeve edge. This is achieved by a metallic cylinder head gasket 4 and an elastic element 5 attached hereto. In the example shown, the attachment is achieved by welding.

FIG. 2 shows a first variant for the seal at the upper sleeve collar. The annular gap 3 formed at the joint position between the cylinder block 1 and the sleeve collar 2 at the upper sleeve edge is sealed, according to this variant, by means of an elastic element 5 which is fitted on the cylinder head gasket 4. The elastic element thereby comprises a metal sheet made of spring steel which has two members, the one member being situated, in the installed state, on the cylinder block and the other member on the sleeve collar. Based on the principle of a rocker, also different spacings between the cylinder head gasket and cylinder block or sleeve collar can be compensated for in this way. The elastic element 5 comprises a beaded metal sheet which is attached across the circumference partially or entirely by welding, soldering, gluing or mechanical restraining on the cylinder head gasket.

In FIG. 3, a variant of the metallic cylinder head gasket according to the invention is illustrated, in which the annular gap 3 is sealed at the upper sleeve collar at the joint position between the cylinder block 1 and the sleeve collar 2 with a rubber buffer 6 as elastic element. Since cylinder block 1 and sleeve collar 2 terminate at a different spacing relative to the cylinder head gasket 4, the rubber buffer 6 has member regions of different thickness.

FIG. 4 shows an embodiment of the cylinder head gasket according to the invention which is based on a combination of the embodiment of FIGS. 2 and 3. In this case, the elastic element comprises a metal sheet 5 made of spring steel which has two members, the members, in the installed state, not being situated directly on the cylinder block or the sleeve collar, instead these are still cushioned by rubber buffers 7 and 7′. The metal sheet 5 is also beaded in this example. In the case where the cylinder block 1 and sleeve collar 2 terminate at different spacings relative to the cylinder head gasket 4, either the height of the rubber buffers 7 and 7′ or the degree of beading on the two members of the metal sheet 5 can be addressed.

FIG. 5 shows finally an embodiment of the cylinder head gasket according to the invention, in which two rubber buffers 7 and 7′ are disposed directly between the cylinder head gasket 4 and the cylinder block 1 or sleeve collar 2. Here also, the different spacings between the cylinder head gasket and cylinder block or sleeve collar are compensated for by different heights of the rubber buffers 7 and 7′. The rubber buffers are thereby generally attached by an adhesive connection to the metallic metal sheet of the cylinder head gasket.

What is claimed is:

1-12. (canceled)

13. A gasket comprising:
an annular elastic element surrounding at least a combustion chamber opening disposed between a cylinder block and a sleeve collar and covering a gap between said cylinder block and said sleeve collar.

14. The gasket of claim 13, wherein said elastic element is a metal sheet formed from spring steel having a first member and a second member, said first member being disposed on the cylinder block and said second member being disposed on the sleeve collar.

15. The gasket of claim 14, wherein said metal sheet is beaded.

16. The gasket of claim 13, wherein said elastic element includes a surface coating on at least one side.

17. The gasket of claim 13, wherein a first free member of said elastic element engages a first groove of the cylinder block.

18. The gasket of claim 13, wherein a second free member of said elastic element engages a second groove of the sleeve collar.

19. The gasket of claim 13, wherein said elastic element is formed from a spring steel having a first member and a second member, said first member includes a first rubber buffer disposed between said elastic element and the cylinder block and said second member includes a second rubber buffer disposed between said elastic element and the sleeve collar.

20. The gasket of claim 19, wherein said first rubber buffer has a different height than said second rubber buffer.

21. The gasket of claim 13, wherein said elastic element includes a rubber buffer and a bead, said rubber buffer being disposed on the block and said bead being disposed on the sleeve collar.

22. The gasket of claim 13, wherein said elastic element comprises two rubber buffers, said first rubber buffer being disposed on the cylinder block and said second rubber buffer being disposed on the sleeve collar.

23. The gasket of claim 13, wherein said elastic element is attached across the circumference at least partially by welding, soldering, gluing or mechanical restraining on the at least one metal sheet of the cylinder head gasket.

24. The gasket of claim 13, wherein said elastic element is inserted below the cylinder head gasket.

25. A metallic cylinder head gasket for an internal combustion engine with a sleeve having at least one metallic layer, into which at least one opening for a combustion chamber is formed comprising:
an annular elastic element completely surrounding the opening integrated in the at least one metallic layer in the region abutting against the combustion chamber through-opening, said elastic element being integrated in the at least one metallic layer such that it bridges a joint position between a cylinder block and a sleeve collar.

26. The gasket of claim 25, wherein said elastic element is a metal sheet formed from spring steel having a first member and a second member, said first member being disposed on the cylinder block and said second member being disposed on the sleeve collar.

27. The gasket of claim 26, wherein said metal sheet is beaded.

28. The gasket of claim 26, wherein said elastic element is formed from a spring steel having a first member and a second member, said first member includes a first rubber buffer disposed between said elastic element and the cylinder block and said second member includes a second rubber buffer disposed between said elastic element and the sleeve collar.

29. The gasket of claim 26, wherein said elastic element includes a rubber buffer and a bead, said rubber buffer being disposed on the block and said bead being disposed on the sleeve collar.

30. The gasket of claim 26, wherein said elastic element comprises two rubber buffers, said first rubber buffers being disposed on the cylinder block and said second rubber buffer being disposed on the sleeve collar.

31. A method of sealing an internal combustion engine with a sleeve having at least one metallic layer, into which at least one opening for a combustion chamber is formed comprising the step of:
providing an annular element at least partially surrounding the combustion chamber opening, said annular element being disposed between a cylinder block and a sleeve collar.

32. The method of claim 31, further comprising attaching said annular element at least partially by welding, soldering, gluing, or mechanical restraining to at least one of said cylinder block and said sleeve collar.
